(19) United States
(12) Patent Application Publication
(10) Pub. No.: US 2011/0228524 A1
(43) Pub. Date: Sep. 22, 2011

(54) FLASHLIGHT WITH PIVOTABLE LEGS

(76) Inventor: Keith G. Greer, Laguna Beach, CA (US)

(21) Appl. No.: 13/129,699

(22) PCT Filed: Jun. 18, 2010
(86) PCT No.: PCT/US2010/039198

§ 371 Date: May 17, 2011

Related U.S. Application Data
(60) Provisional application No. 61/218,293, filed on Jun. 18, 2009.

(51) Int. Cl. F21L 4/00

(52) U.S. Cl. 362/190

(57) ABSTRACT

A flashlight is provided which includes an elongate and generally cylindrical body having a first end and a second end, a lamp assembly attached to the first end, and a removable end cap attached to the second end. The end cap is removable for inserting a power source for powering a light source of the lamp assembly. A sleeve is attached on a lower part of the body at the second end. A slidable leg stand is removably attached to the body and limited in travel along a longitudinal axis of the body between a bottom of the lamp assembly and a top of the sleeve.

### PRIORITY STATEMENT

The present application claims the benefit under 35 U.S.C. §119(e) of U.S. provisional patent application Ser. No. 61/218,293 to the inventor, filed Jun. 18, 2009, the entire contents of which is hereby incorporated by reference herein.

### BACKGROUND

1. Field

Example embodiments of the present invention in general relate to a flashlight supportable by a plurality of pivotable legs.

2. Related Art

There are known mechanisms that hold a flashlight in a self-supporting upright position to free a user's hands. One type of flashlight support includes a clip to hold the flashlight in an upright position. However, since the clip is small relative to the flashlight, the clip does not stably support the flashlight. Other types of flashlight supports include legs that pivot into a tripod orientation to support the flashlight in the free-standing position. However, the legs in these tripod constructions are typically cumbersome and bulky.

Other known devices for holding a flashlight in a free-standing position are bulky and complex, and can make the flashlight difficult to operate. Moreover, the legs in these constructions have a fixed length and are typically attached to the flashlight body at a fixed point on the body. This limits the orientations in which the flashlight can be placed, and also requires a flat, planar surface on which to arrange the legs so as to stably support the flashlight. Such support devices for flashlights cannot be used effectively in uneven terrain conditions.

### SUMMARY

An example embodiment of the present invention is directed to a flashlight. The flashlight includes an elongate and generally cylindrical body having a first end and a second end, a lamp assembly attached to the first end, and a removable end cap attached to the second end. The end cap is removable for inserting a power source for powering a light source of the lamp assembly. A sleeve is attached on a lower part of the body at the second end. A slidable leg stand is removably attached to the body and limited in travel along a longitudinal axis of the body between a bottom of the lamp assembly and a top of the sleeve.

Another example embodiment is directed to a flashlight having an elongate and generally cylindrical body having an upper end and a lower end, a lamp assembly removably attached to the upper end, and a collar dimensioned to slide back and forth the body. The collar includes a plurality of equally spaced hinge mechanisms formed thereon. The flashlight includes a plurality of legs, with each leg having a proximal end received in a corresponding hinge mechanism and a distal end, a collar limit ring attached to a lower portion of the body toward the lower end, and a release attached to the collar for removably securing the collar up and down the body to a desired location, limited in travel between the lamp assembly and collar limit ring.

Another example embodiment is directed to flashlight having a body, lamp assembly attached to the body, and a slidable leg stand removably attached to the body and limited in travel up and down along the length of the body. The leg stand includes a plurality of legs. Each leg is individually pivotable in an arc of about 120 degrees upward from a plane in which the leg is in parallel relation next to the body. Each leg is configured to make an audible sound when pivoted by a user of the flashlight.

### BRIEF DESCRIPTION OF THE DRAWINGS

Example embodiments of the present invention will become more fully understood from the detailed description given herein below and the accompanying drawings, wherein like elements are represented by like reference numerals, which are given by way of illustration only and thus do not limit the example embodiments.

FIG. 1 is a perspective view of a flashlight in accordance with the example embodiments.

FIG. 2 is an exploded view of the flashlight of FIG. 1 to illustrate constituent components thereof.

FIG. 3 is an enlarged front view of a portion of the flashlight of FIG. 1 to illustrate features of the collar in more detail.

FIG. 4 is an enlarged front view of a lower portion of the flashlight of FIG. 1 to illustrate the collar limit ring in more detail.

FIG. 5 is an enlarged view of a portion of the body of the flashlight of FIG. 1 to illustrate the guide channels for the collar in more detail.

FIG. 6 is a top plan view of the leg stand of the flashlight of FIG. 1 to illustrate the guide ribs of the collar and pin of the release in more detail.

FIG. 7 is an enlarged view of a portion of the collar of the flashlight of FIG. 1 to illustrate leg-collar interfaces in more detail.

FIG. 8 is a partial enlarged side view of a leg to illustrate a non-skid foot in further detail.

FIG. 9 is an enlarged bottom plan view to illustrate the on/off button in more detail.

FIG. 10 is a top plan view of the flashlight in a stow/carry configuration.

### DETAILED DESCRIPTION

The example embodiments as to be described hereafter relate to a flashlight with pivotable legs which, in an example, are attached to a single, slidable collar on the flashlight body to provide a stand function for the flashlight. Unless otherwise defined below, terms used to describe the example embodiments should be understood for their plain meaning.

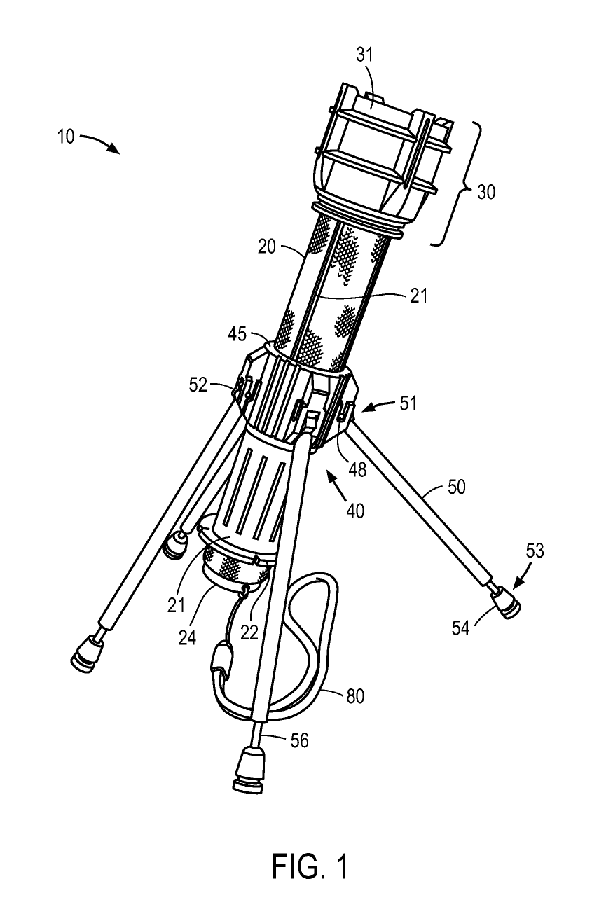

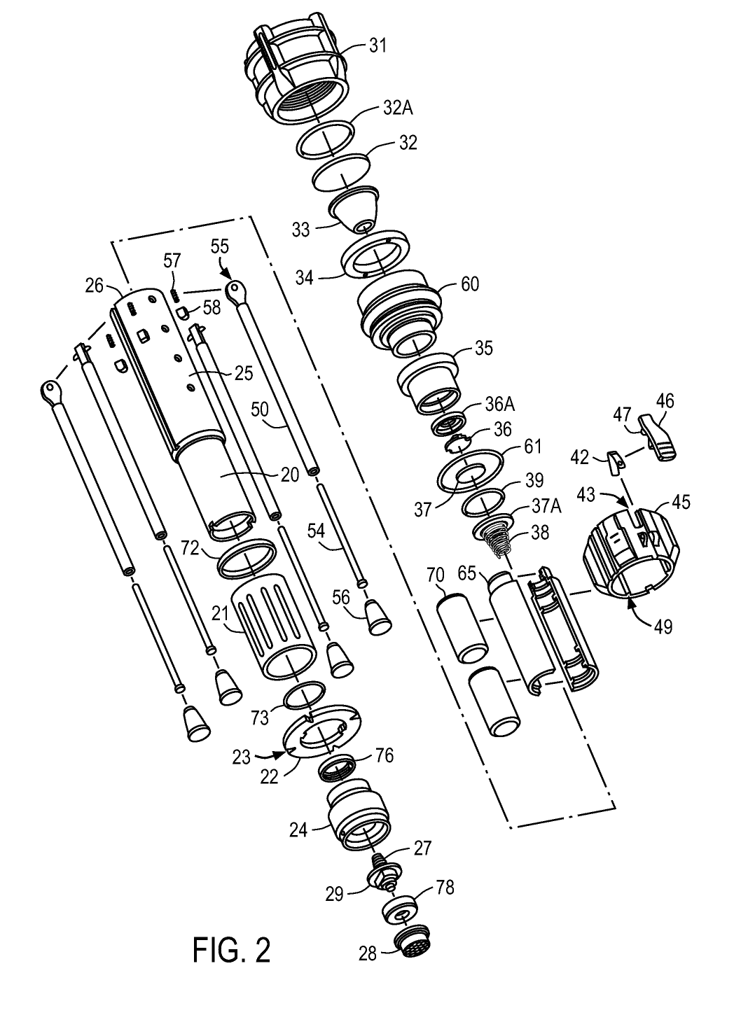

FIG. 1 is a perspective view of a flashlight in accordance with the example embodiments; and FIG. 2 is an exploded view of the flashlight of FIG. 1 to illustrate constituent components thereof. Referring to FIGS. 1 and 2, the flashlight 10 includes a generally elongate body 20 having a longitudinal axis and a lamp assembly 30. As shown, the lamp assembly 30 is attached to one end of the body 20. The flashlight 10 includes a leg stand (shown generally by element 40) attached to the body 20. The leg stand 40 includes a collar 45. A plurality of legs 50 are pivotally attached to the collar 45.

As detailed hereafter, the collar 45 is adapted to be slidable along the longitudinal axis of the body 20. As shown in FIG. 2, the collar 45 may be a single-molded article; however it is within the skill of the art to fabricate collar 45 of two piece construction.

The body 20 includes a plurality of locking bores 25 in spaced-relation to one another for fixedly securing the collar 45 in various positions along the longitudinal axis thereof. A pin 47 of a release 46 is biased by spring pressure of a spring 42 into one of the bores 25 so as to secure the collar 45 to the body 20.

Each leg 50 includes a proximal end 51 attached to the collar 45 via a hinge mechanism 52 formed in the collar 45, and a distal end 53 terminating in a non-skid foot 54. The hinge mechanism 52 permits leg 50's pivot or travel in an arc of up to approximately 120 degrees from the leg 50's stowed or carry position (i.e., taken from a plane in which the leg is secured in parallel relation next to the body on the leg stand 40) against body 20 upward.

Referring to FIG. 2, the lamp assembly 30 includes a head 31 that is affixed to a connector 60. The connector 60 includes a necked down threaded portion for engagement to collar 45 and includes a protective fixed plastic gasket 61 there between. In an example, head 31 may be formed of ABS. An acrylic lens 32 is supported within a circular lens collar 32A formed within the inner periphery of the head 31. A reflector 33 abuts the lens 32 and is supported in a reflector holder 34 that is removably attached to a connector 60 via threaded fastening means, for example.

The connector 60 is also attached to an LED holder 35 which in turn supports the lamp, configured in this example as a high-intensity LED bulb 36 that is retained within a circular bulb retainer 36A. One or more LED bulbs 36 may be provided on the printed circuit board (PCB) 37 that is supported within LED holder 35. In an example, the LED bulb(s) has/have an intensity of at least 120 lumens. In one example, the LED bulb 36 may be an off-the-shelf product such as the 3W Q5 4-Mode 180-Lumen bulb from CREE®.

The PCB 37 is biased against a spring 38 and pressure washer 39 so as to be in constant contact with a power source 70 via a conductive plate 37A of a DC energy extender conduit 65. The DC energy extender conduit 65 is shown as a two piece construction, although it is within the skill of the art to fabricate the DC energy extender conduit 65 as a single-molded article.

In an example, the power source 70 may be embodied by one or more rechargeable batteries with cells having any of nickel metal hydride (NIMH), nickel cadmium (NiCd) or lithium-ion (Li-ion) cell chemistry. In another example, the power source 70 may include one or more rechargeable Li-ion batteries. In a specific example, the power source may comprise a pair of 3V Propel® Model CR123A rechargeable lithium cells by TENERGY®. Alternatively, the power source 70 may be embodied by a plurality of disposable alkaline or lead-acid batteries.

An end cap 24, which in an example is formed of TPR or alternatively cast aluminum, but alternatively could be composed of stainless steel, ABS or a carbon-fiber composite for example, is attached to the lower end of body 20. An optional material carry strap 80 may be attached to end cap 24.

End cap 24 includes a bore through which extends a dual-position rubberized switch 29 for high and low power operation. End cap 24 seats against o-ring 73, which in turn bears on power source 70. The switch 29 is biased against aluminum pressure washer 76 and a metal (iron or steel) spring 27 so as to contact the power source 70 upon switch 29 actuation. A switch cap 28 protects the switch 29 and serves as the contact point for power on/off of flashlight 10.

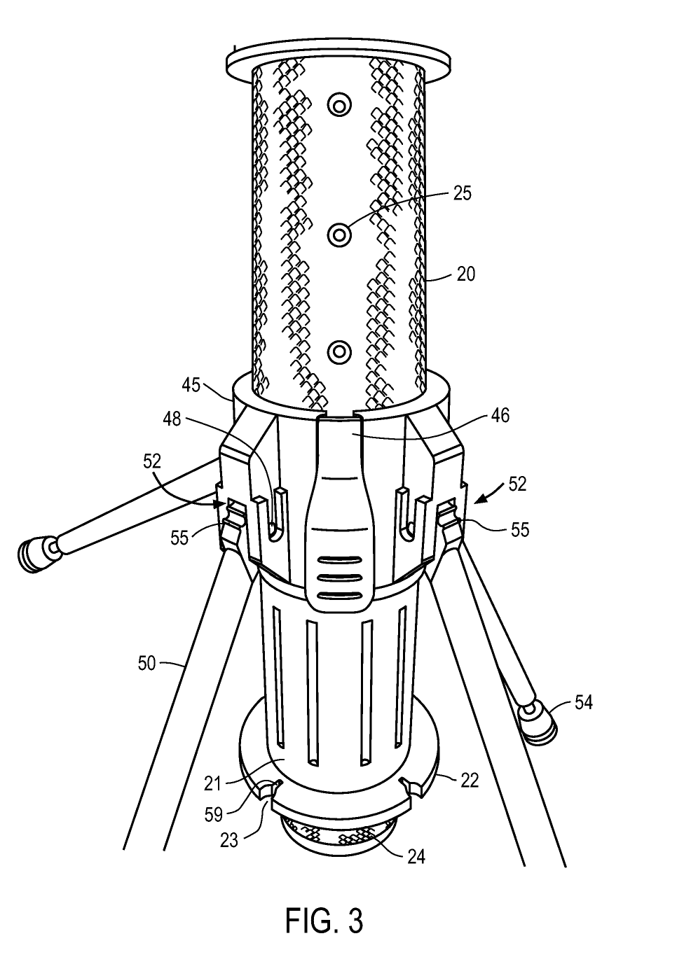

Reference should be made to FIGS. 3-8 for the following discussion, with occasional reference back to FIG. 2. FIG. 3 is an enlarged front view of a portion of the flashlight of FIG. 1 to illustrate features of the collar in more detail. As previously noted, the collar 45 is adapted to be slidable along the longitudinal axis of the body 20. In an example, the collar 45 may be formed from cast aluminum tubing using a metal casting process such as sand casting, die casting, or investment casting, for example. Alternatively, collar 45 may be composed of stainless steel or other metal. The collar 45 is shown as a single-molded article, although it is within the skill of the art to fabricate collar 45 of multiple pieces or parts/halves.

In another example, collar 45 may be formed by an injection molding process from a high impact plastic, such as Acrylonitrile Butadiene Styrene (ABS), which is an easily machined, tough, low cost rigid thermoplastic material with high impact strength, and may be a desirable material for turning, drilling, milling, sawing, die-cutting, shearing, etc. Virgin ABS may be mixed with a plastic regrind of ABS or another lightweight, durable plastic material. ABS is merely an example material, equivalent materials may include various thermoplastic and thermoset materials, such as talc-filled polypropylene, high strength polycarbonates such as GE Lexan®, or blended plastics.

There are many known injection molding machines for forming plastic injection molds, other plastic molding processes such as vacuum forming may be used. Alternatively, collar 45 may be formed of cast aluminum, stainless steel or other metal using a metal casting process such as sand casting, die casting, or investment casting, for example. In a further alternative, collar 45 may be composed of a carbon-fiber material.

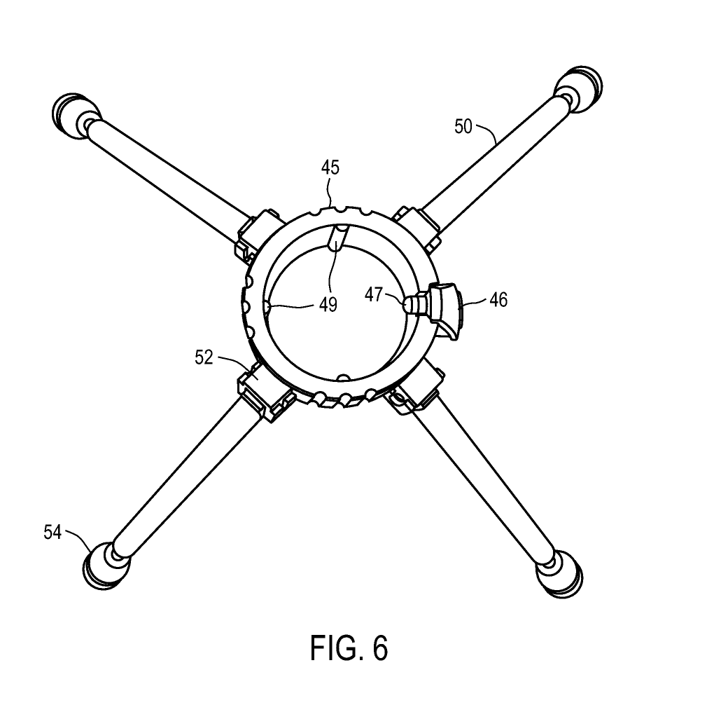

The body 20 may be formed of aluminum tubing; alternatively of steel tubing, ABS or from a carbon-fiber material. The body 20 includes a plurality of locking bores 25 in spaced-relation to one another for fixedly securing the collar 45 in various positions along the longitudinal axis thereof. Each locking bore 25 is provided to receive the pivoting engagement of a pin 47 of a release 46 of the collar 45. The pin 47 may best be seen in FIGS. 2 and 6. The pin 47 is biased by spring pressure of a spring 42 (FIG. 2) into one of the bores 25 so as to secure the collar 45 to the body 20. A lower surface of the release 46 is depressible under user force to rotate a cam against spring pressure, overcoming the spring tension so as to lift the pin 47 out of a given locking bore 25, thereby enabling the collar 45 to slide up and down the body 20 to a desired location, its travel limited at the upper end by the head 31 of the lamp assembly 30 and limited at the lower end by a circular collar limit ring 72. Spring pressure of the spring 42 then seats the pin 47 in the bore 25 in snap fit relation as the user lets go of the release 46, for example, securing the collar 45 in a desired position on the body 20.

Accordingly, a lower surface of the release 46 is depressible under user force to rotate a cam against spring pressure of spring 42, overcoming the spring tension so as to lift the pin 47 out of a given locking bore 25, thereby enabling the collar 45 to slide up and down the body 20 to a desired location, its travel limited at the upper end by the head 31 of the lamp assembly 30 and limited at the lower end by a circular collar limit ring 72. Spring pressure then seats the pin 47 in the bore 25 in snap fit relation as the user lets go of the release 46, for example, securing the collar 45 in a desired position on the body 20.

Release 46 and pin 47 may be made of ABS. The spring (not shown) which imparts the levered counterforce against user pressure on the bottom end of the release 46 may be formed of steel, for example.

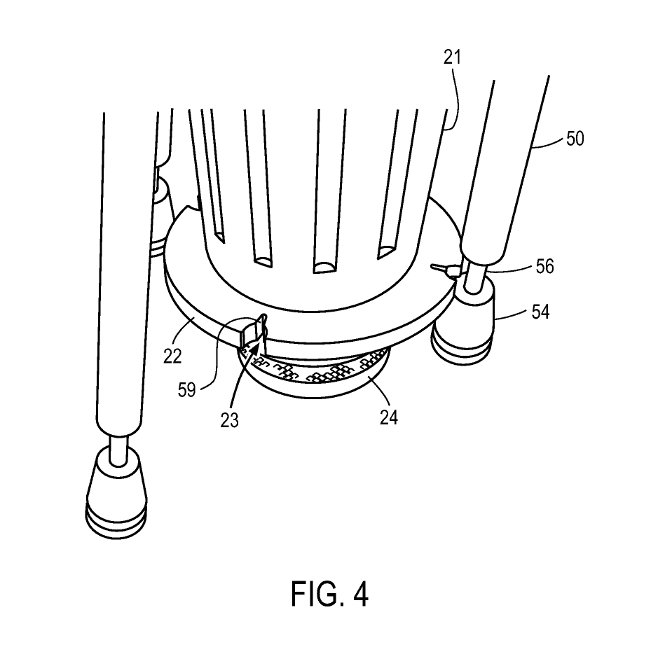

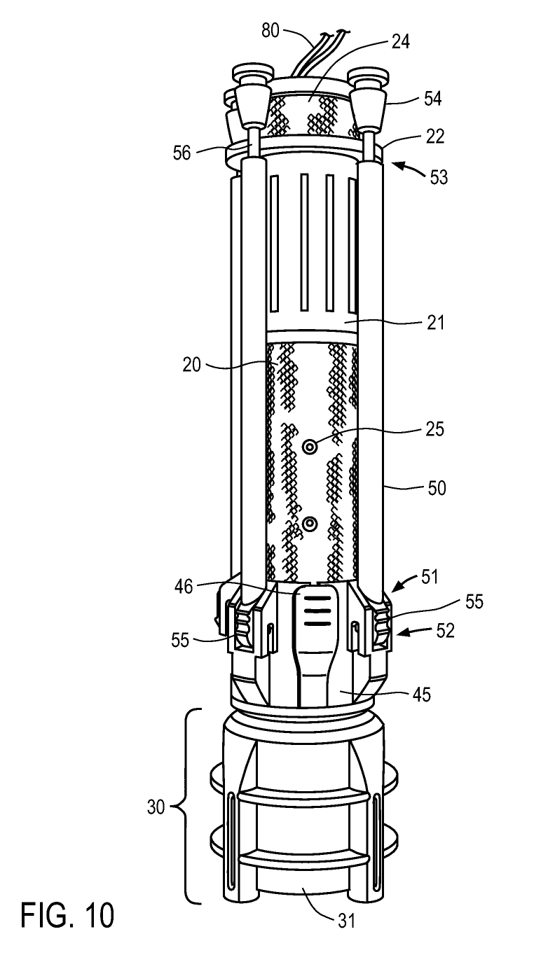

FIG. 4 is an enlarged front view of a lower portion of the flashlight of FIG. 1 to illustrate the collar limit ring in more detail. Referring to FIG. 4, a rubber sleeve 21 is attached to a lower end of the body 20 so as to provide a grip surface, and abuts the collar limit ring 72 of the body 20. Sleeve 21 may be formed of TPR; alternately it may be made of TPE. A leg retaining ring 22 abuts the sleeve 21 and fits over the bottom end of body 20. The leg retaining ring 22 may be formed of aluminum, ABS or a carbon-fiber composite. Leg retaining ring 22 further includes a plurality of spaced catch recesses 23 which receive a portion of the skid foot 54 of each leg 50, particularly leg portions 56, so as to secure the legs 50 in parallel relation to the body 20, as shown best in FIG. 10.

For example, to secure the legs, the collar 45 is moved up to the top most bore 25 so that the leg portions 56 come into alignment with recesses 23. Each recess 23 has a wider opening that narrows down to a tighter catch 59. Catch 59 is dimensioned to be slightly narrower than the diameter of leg portion 56 so that a leg portion 56 attaches within a corresponding catch 59 in snap-fit relation to secure the leg alongside body 20. All four legs 50 secured within recesses 23 signify a carry or stowed configuration for the flashlight 10, for example. This is best shown in FIG. 10.

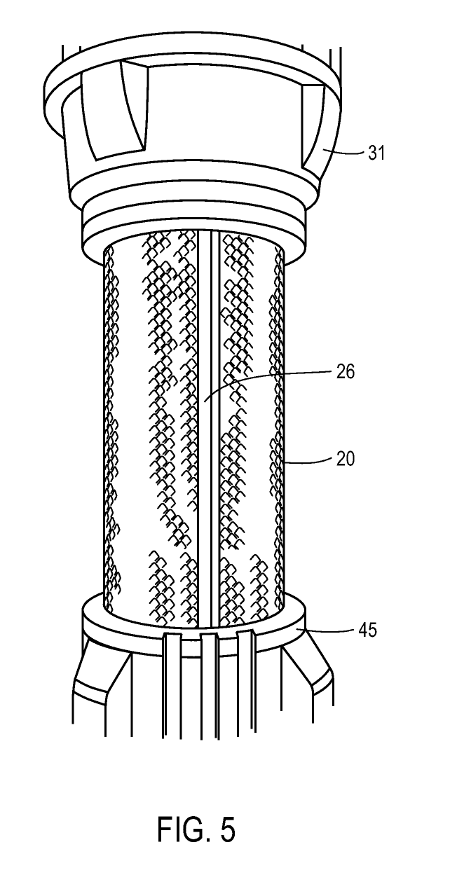

Referring primarily to FIGS. 5 and 6, each of the collar 45 and body 20 include guide means to align the collar 45 with the body 20. The body 20 includes a plurality of spaced, grooved alignment channels 26 formed in its exterior surface along its longitudinal axis (See FIG. 5). In an example, there are three (3) equally spaced channels 26. These channels 26 are designed to match up with alignment guide ribs 49 on the interior surface of the collar 45, as best seen in the top plan view of FIG. 6. The view of FIG. 6 also illustrates the pin 47 extending through a semi-circular slot opening 43 (FIG. 2) at the top of collar 45 into the collar 45 interior; this permits travel into a desired locking bore 25 once the pin 47 is lined up with a given bore 25 to secure collar 45 in place, whereupon the release 46 is released to allow spring pressure from spring 42 to seat the pin 47 into the bore 25 formed in body 20.

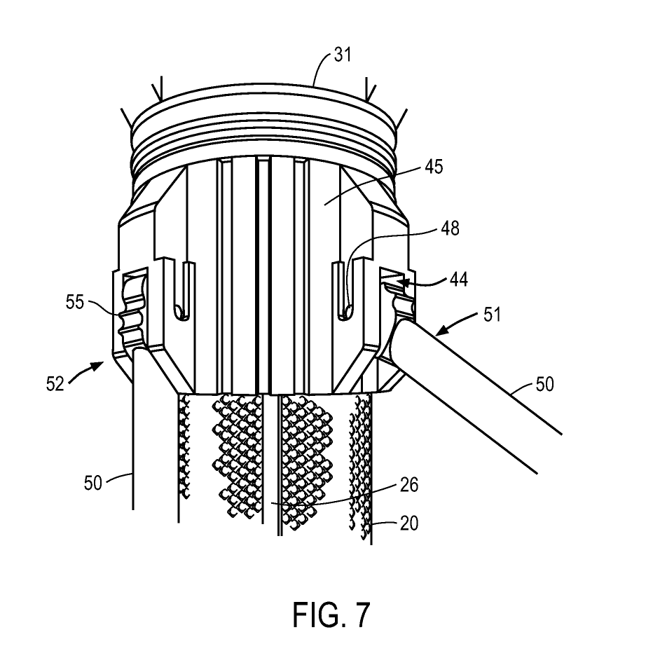

FIG. 7 is an enlarged view of a portion of the collar of the flashlight of FIG. 1 to illustrate leg-collar interfaces in more detail. The hinge mechanism 52 (of which there are four) may be embodied by a fixed block with an open cavity 44 to receive the proximal end 51 of a corresponding leg therein. Each leg 50 may have a bore (not shown) through which a pivot pin 48 traverses there through for attachment between faces of the fixed block, an internal spring (57, see FIG. 2) within the cavity 44 of the hinge mechanism 52 which imparts a counter tension to the pivot pin 48 at the proximal end 51 of the leg 50 as the leg 50 is rotated/pivoted in a range of up to about 120 degree range from its vertical stowed or carry position in the same longitudinal plane as the body 20 (for example, when abutting the leg retainer ring 22) upward. In an example, the internal spring 57 may be composed of spring iron. Alternatively, any bearing and ramp construction as is known in the art or equivalent bearing-based assembly which permits pivoting and/or rotational movement can replace the internal spring construction within cavity 44 of the hinge mechanism 52.

Accordingly, the pivot pin 48 is biased against by spring 57 to permit controlled pivoting and/or rotational movement. As noted, the hinge mechanism 52 permits the leg 50 to be pivotable in an approximately 120 degree arc upward from the leg 50's stowed position along the side of the body 20 to increase the variability of leg adjustment.

Moreover, the proximal end 51 of each leg 50 includes a plurality of spaced, sequential ridges or ribs 55 which contact an interior ramp or protruding element (58, see FIG. 2) within each cavity 44 of the fixed block of the hinge mechanism 52 designed to secure a leg 50 to the collar 45. Accordingly, as a given leg 50 is pivoted (in either direction) within the cavity 44, an audible, tactile noise or sound is imparted as a given rib 55 comes into contact with a corresponding ramp 58 within cavity 44.

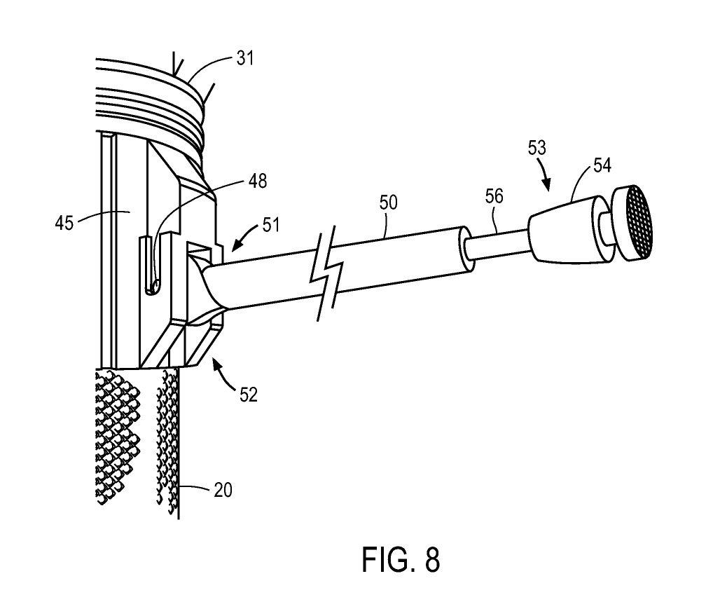

FIG. 8 is a partial enlarged side view of a leg to illustrate a non-skid foot in further detail. The leg 50 may be formed of aluminum in one example; alternatively each leg may be composed of a hard plastic such as ABS or other high strength polycarbonate materials. Each non-skid foot 54 may be constructed of a rubber or plastic material to serve as a stop for the leg 50. An example material for foot 54 is a thermoplastic elastomer (TPE). TPE is a plastic material compounded to display characteristics like an elastomer. TPE is normally tough, cut resistant, flexible, smooth, typically with vibrant coloring. Alternatively, foot 54 may be formed of a malleable plastic such as TPR.

In a variation, each leg 50 may include a concentric telescoping leg portion 56. Leg portion 56 may be adapted to be extended and/or locked at a desired length so as to provide adjustability in the total length of the leg 50.

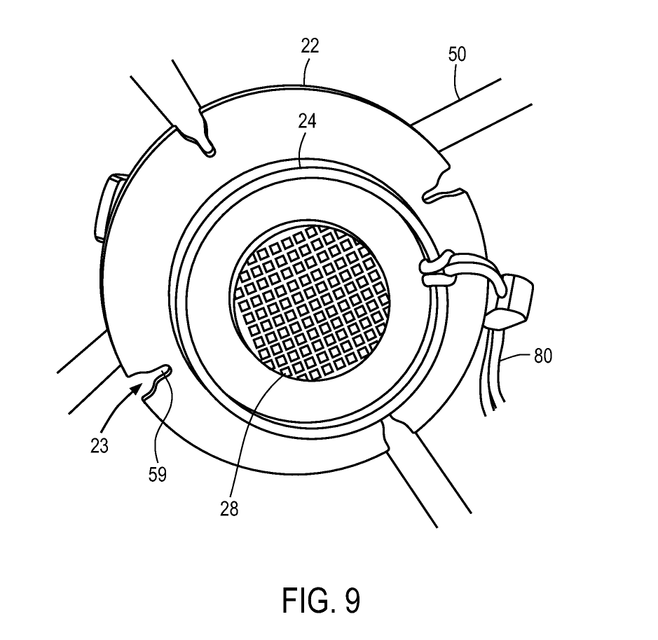

FIG. 9 is an enlarged bottom plan view to illustrate the on/off button in more detail. The switch cap 28 protects the switch 29 and serves as the contact point for the user to turn the flashlight 10 on and off. Switch 29 is formed of ABS; switch cap 28 may be formed of any of ABS, TPE or TPR for example. A protective pressure washer 78 is situated between switch 29 and switch cap 28 (FIG. 2).

FIG. 10 is a top plan view of the flashlight in a stow/carry configuration. As shown in FIG. 10. All four legs 50 are shown attached to the collar limit ring 22 so that the flashlight 10 may be securely stowed or hand-carried. Optionally, flashlight 10 may be tied off to an external structure via carry strap 80.

The example embodiments being thus described, it will be obvious that the same may be varied in many ways. Such variations are not to be regarded as departure from the example embodiments of the present invention. All such modifications as would be obvious to one skilled in the art are intended to be included within the following claims.

What is claimed is:

1. A flashlight, comprising:
an elongate and generally cylindrical body having a first end and a second end,
a lamp assembly attached to the first end,
a removable end cap attached to the second end, the end cap removable for inserting a power source for powering a light source of the lamp assembly,
a sleeve attached on a lower part of the body at the second end,
a slidable leg stand removably attached to the body and limited in travel along a longitudinal axis of the body between a bottom of the lamp assembly and a top of the sleeve.

2. The flashlight of claim 1, wherein the leg stand includes a plurality of pivotable legs thereon.

3. The flashlight of claim 1, wherein each of legs are pivotable in an arc of about 120 degrees upward, taken from a plane in which the leg is secured in parallel relation next to the body on the leg stand.

4. The flashlight of claim 1, wherein the body includes a plurality of lock bores in vertical spaced relation thereon to lock the leg stand at different elevations thereon between the bottom of the lamp assembly and the top of the sleeve.

5. The flashlight of claim 1, wherein the leg stand includes a release that cooperates with the plurality of lock bores to vary the location at which the leg stand is secured in a given lock bore between the bottom of the lamp assembly and the top of the sleeve.

6. The flashlight of claim 1, wherein the leg stand includes a plurality of pivotable legs thereof, each of which are configured to make an audible sound when pivoted by a user of the flashlight.

7. The flashlight of claim 1, further comprising:
a circular retaining ring dimensioned to slide over the body and provided between a bottom of the sleeve and the end cap for securing legs of the legs stand against the body.

8. The flashlight of claim 1, further comprising:
a collar limit ring formed as part of the body and abutting the top of the sleeve for terminating the travel of the leg stand at the lower end of the body.

9. The flashlight of claim 1, wherein the leg stand includes:
a collar dimensioned to slide over the body, the collar having a plurality of equally spaced hinge mechanisms,
a plurality of legs, each leg having a proximal end received in a corresponding hinge mechanism and a distal end terminating in a rubberized, non-skid foot, and
a release attached to the collar for removably securing the leg stand to a desired location on the body between the bottom of the lamp assembly and top of the sleeve.

10. The flashlight of claim 9, wherein
the release includes a pin formed thereon,
the release is biased against spring pressure to seat the pin into one of a plurality of lock bores formed in the body in vertical spaced relation thereon to lock the collar at different elevations between the bottom of the lamp assembly and top of the sleeve, and
the release actuated by a user to overcome the spring pressure so as to slide the collar to a desired lock bore position.

11. A flashlight, comprising:
an elongate and generally cylindrical body having an upper end and a lower end,
a lamp assembly removably attached to the upper end,
a collar dimensioned to slide back and forth the body, the collar having a plurality of equally spaced hinge mechanisms formed thereon,
a plurality of legs, each leg having a proximal end received in a corresponding hinge mechanism and a distal end,
a collar limit ring attached to a lower portion of the body toward the lower end, and
a release attached to the collar for removably securing the collar up and down the body to a desired location, limited in travel between the lamp assembly and collar limit ring.

12. The flashlight of claim 11, wherein
the release includes a pin formed thereon,
the release is biased against spring pressure to seat the pin into one of a plurality of lock bores formed in the body in vertical spaced relation thereon to lock the collar at different elevations between the bottom of the lamp assembly and collar limit ring, and
the release is actuated by a user to overcome the spring pressure so as to slide the collar to a desired lock bore position.

13. The flashlight of claim 11, wherein each leg is pivotable in an arc of about 120 degrees upward from a plane in which the leg is in parallel relation next to the body.

14. The flashlight of claim 11, wherein the hinge mechanism includes:
a fixed block with a cavity for receiving the proximal end of the leg therein, the proximal end having a bore through which extends a pivot pin that is attached between interior facing surfaces of the fixed block, and
a spring element within the cavity that is biased against the pivot pin as the leg is pivoted within the cavity of the fixed block.

15. The flashlight of claim 11, wherein
the hinge mechanism includes a ramp element, and
the proximal end of the leg includes a series of spaced ribs, the ribs sequentially contacting the ramp element as the leg is pivoted in the hinge mechanism to impart an audible sound.

16. The flashlight of claim 11, wherein
the collar includes a plurality of guide ribs on an interior surface thereof,
the body includes a plurality of guide channels formed on an outer surface thereof, the ribs aligning with the channels so that the collar slides over the body in alignment.

17. The flashlight of claim 11, further comprising:
a removable end cap attached to the lower end, and
a power source insertable through the lower end for powering a light source of the lamp assembly.

18. The flashlight of claim 17, wherein the end cap has a switch attached thereto, the switch covered by a rubberized switch cap forming an outer end of the end cap and serving as an on/off button of the flashlight.

19. The flashlight of claim 17, wherein the power source further includes one or more battery cells selected from a group comprising cells having a nickel metal hydride (NiMH), nickel cadmium (NiCd) lithium-ion (Li-ion), alkaline and lead-acid cell chemistry.

20. A flashlight, comprising:
a body,
a lamp assembly attached to the body,
a slidable leg stand removably attached to the body and limited in travel up and down along the length of the body, the leg stand including a plurality of legs, each leg individually pivotable in an arc of about 120 degrees upward from a plane in which the leg is in parallel relation next to the body, each leg configured to make an audible sound when pivoted by a user of the flashlight.
